(19) United States
(12) Patent Application Publication
(10) Pub. No.: US 2005/0259054 A1
(43) Pub. Date: Nov. 24, 2005

(54) METHOD OF DRIVING ORGANIC LIGHT EMITTING DIODE

(76) Inventor: JIE-FARN WU, MIAOLI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,478

(22) Filed: Apr. 14, 2003

(51) Int. Cl. G09G 3/32

(52) U.S. Cl. 345/82

(57) ABSTRACT

A method of driving an organic light emitting diode using an applied voltage to increase the voltage of the anode is provided. The voltage of the anode is detected and compared to a reference voltage. When the voltage of the anode is lower than the reference voltage, a voltage source is applied to precharge the anode of the organic light emitting diode. When the voltage of the anode reaches the reference voltage, the precharge process is stopped. Alternatively, the reference voltage can be dynamically obtained using a sample/hold circuit to dynamically perform sampling on the output voltage of a constant current source.

### BACKGROUND OF INVENTION

1. Field of the Invention

The invention relates in general to a method of driving an organic light emitting diode, and more particularly, to a passive driving method of an organic light emitting diode.

2. Related Art of the Invention

To comply with versatility of modern information apparatus, the flat panel that replaces the cathode ray tube (CRT) display due to the trends of being thin, light, short, small and power saving is strongly demanded. Currently, the available flat panel display techniques include plasma display, liquid crystal display (LCD), electroluminescent display, light emitting diode (LED), field emission display, electrochromic display, and organic light emitting diode (OLED) display.

Two types of luminescent materials, including small molecular material and polymer material, have been employed in the organic light emitting diode display. Having the characteristics of: (1) viewing angle independence; (2) low fabrication cost; (3) high response speed (hundred times of that of liquid crystal display); (4) low power consumption; (5) applicability of direct current drive of portability machine; (6) applicability in broad temperature range; and (7) light weight and further shrinkable in size and thickness in accordance with hardware equipment, the organic light emitting diode display has great development potential among various flat panel displays and may become the leading flat panel display in the next generation.

Currently, the organic light emitting diode has been successfully applied to flat panel display, and particularly, the passive matrix has been commercialized. The conventional driving system includes two modes, that is, the cathode sequential scanning mode and the anode sequential scanning mode. Based on the characteristic of the organic light emitting diode, a constant current source output is required for either mode.

Referring to FIG. 1, a conventional driving circuit for a passive organic light emitting diode array is illustrated. The organic light emitting diode array 10 includes a plurality of organic light emitting diodes 12 arranged as an array with a plurality of rows C₁, C₂, . . . , Cₙ and a plurality of columns A₁, A₂, . . . , Aₙ. The cathodes of the organic light emitting diodes in the same row are connected together as a cathode line, while the anodes of the organic light emitting diodes in the same column are connected together as an anode line. Each anode line is connected to a constant current source I or a ground terminal via a switch, while each cathode line is connected to a constant voltage source V or the ground terminal via a switch. To drive an organic light emitting diode, for example, the organic light emitting diode at the intersection of the anode lines A₂, A₃ and the cathode line C₂, the anode lines A₂ and A₃ are connected to an output of the constant current source I, while the other anode lines are coupled to the ground GND. Meanwhile, the cathode line C₂ is coupled to the ground GND, while other cathode lines are coupled to the voltage source V. Thereby, the constant current I provides a forward bias to the organic light emitting diode at the intersection of the anode lines A₂, A₃ and the cathode line C₂, so as to drive the organic light emitting diode to generate a light. Meanwhile, other organic light diodes are reverse biased and cannot emit a light.

However, due to the intrinsic physical property of the organic light emitting diode, a parasitic capacitance exists. As shown as the equivalent circuit diagram in FIG. 2, an actual organic light emitting diode includes a light emitting diode D and a parasitic capacitor C. The capacitance characteristic intrinsic to the organic light emitting diode affects the turn-on speed of the driving circuit. When the voltage across the cathode and anode of the organic light emitting diode cannot instantly reaches an appropriate value, the required luminance of the organic light emitting diode cannot be obtained. Further, as shown in FIG. 3, the conventional driving system of the organic light emitting diode suffers the problem of excessively long rising time for conducting the diode due to the parasitic capacitance of the organic light emitting diode panel. When a constant current is output from the circuit, the organic light emitting diodes in the same column are charged to slow down the rising speed of the voltage, so as to scatter the current for driving the organic light emitting diode.

At the instant that one organic light emitting diode pixel is illuminated, if a constant current is used to drive each segment, a part of the current is wasted for charging the parasitic capacitor due to the parasitic capacitance intrinsic to the organic light emitting diode. Consequently, the voltage differential across the organic light emitting diode consumes a longer time to reach the required voltage. As the light intensity output by the organic light emitting diode is proportional to the input current, the parasitic capacitance causes insufficient luminance and predetermined value.

### SUMMARY OF INVENTION

The present invention provides a method for driving an organic light emitting diode that uses precharge mechanism to precharge an anode of the organic light emitting diode, such that the turn-on speed is increased, and the appropriate driving voltage can be reached instantly.

The present invention provides a method for driving an organic light emitting diode uses sample/hold circuit (S/H) to dynamically vary the reference voltage of a precharge circuit. Thereby, when the circuit outputs a current, the corresponding reference voltage for each organic light emitting diode in the same column can be dynamically adjusted. The rising speed of the voltage of the anode of the organic light emitting diode is increased without diffusing the current driving the organic light emitting diode.

The present invention provides a method for driving an organic light emitting diode that adjusts the voltage source dynamically via a sample/hold circuit within a predetermined charging time. Thereby, the charging time is shortened when the uniformity of the voltage output of the anode is highly demanded.

According to the driving method of organic light emitting diode provided by the present invention, the anode of the organic light emitting diode is precharged to provide sufficient brightness uniformity of the organic light emitting diode. In addition, the present invention enhances the turn-on speed and reducing the rising time of the organic light emitting diode.

The steps of the method of driving the organic light emitting diode provided by the present invention are described as follows.

A voltage is applied to an organic light emitting diode to increase a voltage of an anode thereof. The voltage of the anode is detected and compared to a reference voltage. When the voltage of the anode is lower than the reference voltage, a voltage source is applied to the anode to perform precharge thereon. When the voltage of the anode reaches the reference voltage, the precharge step is stopped.

In one embodiment of the present invention, a voltage is applied to an organic light emitting diode to increase a voltage of an anode thereof. The voltage of the anode is detected. According to a sampling signal, sample/hold is performed on the detected voltage of the anode, and a voltage obtained by sampling is used as a reference voltage. The detected voltage is compared to the reference voltage. When the detected voltage is lower than the reference voltage, a voltage source is used to precharge the anode of the organic light emitting diode. When the voltage of the anode reaches the reference voltage, the precharge performed on the anode of the organic light emitting diode is stopped.

The present invention further provides a method of driving an organic light emitting diode as follows. A voltage is applied to the organic light emitting diode to increase a voltage of an anode thereof. The voltage of the anode is detected. According to a first sampling signal and a second sampling signal, sample/holdn is performed on the anode of the organic light emitting diode to obtain a first voltage and a second voltage. According to the differential between the first and second voltages, a voltage is generated. The anode of the organic light emitting diode is then precharged within a predetermined charging time according to such voltage.

### BRIEF DESCRIPTION OF DRAWINGS

These, as well as other features of the present invention, will become more apparent upon reference to the drawings wherein:

FIG. 1 shows a conventional passive driving circuit of an organic light emitting diode array;

FIG. 2 shows an equivalent circuit for a turn-on rising time for driving an organic light emitting diode array using the conventional driving method;

FIG. 3 showing the timing diagram of the turn-on rising time for the conventional method of driving an organic light emitting diode;

FIG. 4 shows circuit diagram of a passive driving circuit for an organic light emitting diode in a first embodiment of the present invention;

FIG. 5 shows the turn-on rising time for the organic light emitting diode for the driving method provided by the present invention;

FIG. 6A shows a circuit diagram of a passive driving circuit for an organic light emitting diode in a second embodiment of the present invention;

FIG. 6B shows the signal sampling timing diagram for a sample/hold circuit performing signal;

FIG. 7A shows a circuit diagram of a passive driving circuit for an organic light emitting diode in a third embodiment of the present invention;

FIGS. 7B to 7D shows the signal sampling timing diagram for each sample/hold circuit performing signal as shown in FIG. 7A;

FIG. 8 shows the process flow of the driving method in the first embodiment;

FIG. 9 shows the process flow of the driving method in the second embodiment; and

FIG. 10 shows the process flow of the driving method in the third embodiment.

### DETAILED DESCRIPTION

The main concept of the present invention includes detecting the voltage of the anode of an organic light emitting diode while lighting up the organic light emitting diode and comparing the voltage of the anode with a reference voltage. The voltage of the anode is precharged to a predetermined value to reduce the rising time for turning on the organic light emitting diode. That is, the present invention uses a voltage detection feedback design to obtain instantaneous charge effect. Thereby, the organic light emitting diode obtains a stable voltage immediately after being turned on. Various embodiments of the present invention are described as follows.

### First Embodiment

Referring to FIG. 4, a passive driving circuit of an organic light emitting diode of a first embodiment according to the present invention is illustrated. For the convenience of description, only one light emitting diode in a whole organic light emitting diode array is described. People of ordinary skill in the art can integrate the whole organic light emitting diode according thereto.

In FIG. 4, a precharge circuit 40 is electrically connected to an anode of an organic light emitting diode 30. The anode of the organic light emitting diode 30 is connected to a constant current source I and a voltage source Vₚₚ via a switching device 32, while the cathode thereof is connected to a voltage V or a grounded GND via a switching device 34 for providing reverse bias. To light up the organic light emitting diode 30, the switching device 32 is closed to provide the constant current I to the organic light emitting diode 30, while the switching device 34 is connected to the ground GND. Thereby, the organic light emitting diode 30 is forward biased and conducted. Otherwise, the organic light emitting diode 30 is switched off.

The precharge circuit 40 includes a switching device 42 and a comparator 44. The comparator has an input terminal such as a negative (−) terminal coupled to the anode of the organic light emitting diode 30, another input terminal such as a (+) positive terminal coupled to a reference voltage V_{ref}. The switching device 42 has three terminals, including a terminal A electrically connected to the anode of the organic light emitting diode 30 and the negative input terminal of the comparator 44, a terminal B coupled to a source voltage Vₚₚ, and a terminal C coupled to an output terminal of the comparator 44.

At the instant that the organic light emitting diode 30 is lighted up, the voltage of the anode thereof is fed back to the negative input terminal of the comparator 44 and is compared to the predetermined reference voltage V_{ref}. The output of the comparator 44 is used as a switch to input the voltage source Vₚₚ to the anode of the organic light emitting diode 30. Since the voltage of the anode only starts rising from zero at the instant that the organic light emitting diode 30 is lighted up, the voltage of the anode is smaller than the reference voltage V_{ref}. The output of the comparator 44 thus conducts the switching device 42, that is, the terminal A is switched to the terminal B, allowing the voltage source Vₚₚ to charge the anode of the organic light emitting diode 30, so as to increase the speed of raising the voltage of the anode. Meanwhile, as the voltage of the anode approaches the predetermined reference voltage V_{ref}, the switching device 42 is ref switched off. The voltage source Vₚₚ is thus disconnected with the anode of the light emitting diode 30. Therefore, the voltages at two input terminals of the comparator 44 are the same. The output of the comaprator 44 is thus zero to switch off the switching device.

In the practical application, the reference voltage V_{ref} applied to the positive input terminal of the comparator can be adjusted externally according to various applications. This embodiment uses a constant voltage Vₚₚ to adjust the value of the reference voltage V_{ref}. In addition, since another input terminal (the negative terminal in this embodiment) is the output terminal of the current source I, so that the output feedback of the current source can be used to adjust the precharge time.

In addition, the above switching device 42 includes a semiconductor switching device such as the metal-oxide semiconductor (MOS) transistor to control on and off status of the charge mechanism of the anode of the organic light emitting diode 30. For example, a MOS transistor has a gate used as the C terminal of the switching device 42, the source and drain regions are used as the A and B terminals thereof. Before the voltage of the anode of the organic light emitting diode 30 reaches the reference voltage V_{ref}, the output of the comparator 44 is high to conduct the MOS transistor 42. In contrast, when the voltage of the anode reaches the reference voltage V_{ref}, the output of the comparator 44 is low to switch off the MOS transistor 42. Therefore, the connection between the voltage source Vₚₚ and the anode of the organic light emitting diode 30 is cut off to terminate the precharge process.

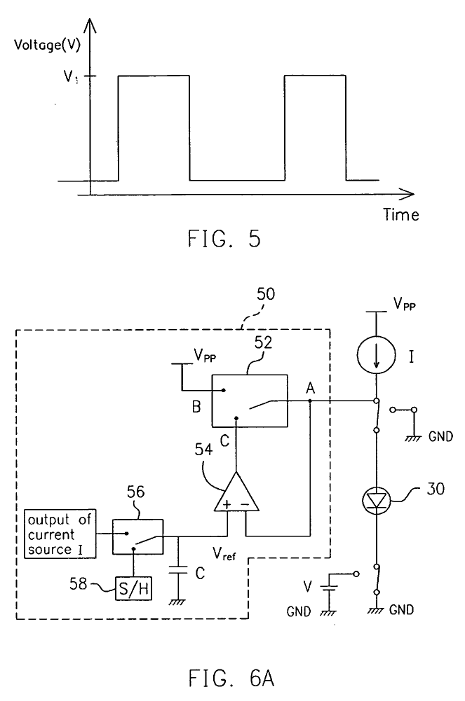

FIG. 5 shows the timing diagram of turn-on rising time of the precharge mechanism for driving the organic light emitting diode. As the present invention uses a voltage detection feedback design to achieve the instant precharge, a stable voltage is immediately obtained after the organic light emitting diode is conducted. Therefore, the precharge circuit 40 shortens the rising time, increases the brightness, and uniformizes the brightness of the organic light emitting diode 30.

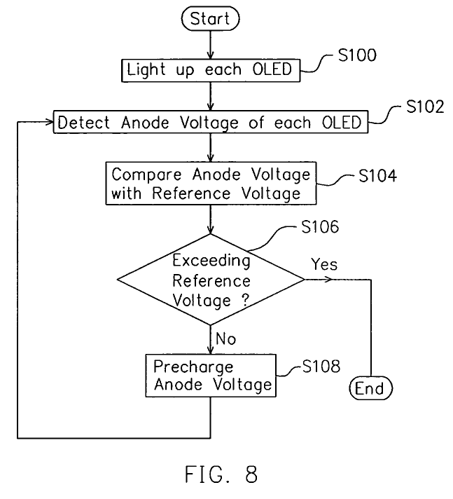

FIG. 8 shows a process flow of the method for driving an organic light emitting diode in the first embodiment. Referring to FIGS. 4 and 8, in step S100, the organic light emitting diode 30 is lighted up. Meanwhile, the voltage of the anode of the organic light emitting diode 30 is increased. In step S102, the voltage of the anode is detected and fed back to an input terminal of a comparator. In step S104, the detected voltage is compared to a predetermined reference voltage.

In step S106, when the detected voltage is lower than the reference voltage, a voltage source is applied to precharge the anode. The steps S102 to S106 are continued until the voltage of the anode reaches the reference voltage, and the precharge is stopped.

### Second Embodiment

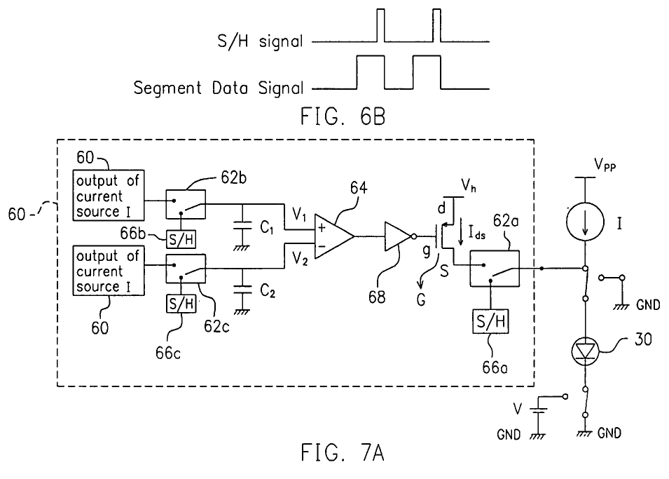

Referring to FIG. 6A, a circuit diagram of a driving circuit of an organic light emitting diode is illustrated. For the convenience of description, only the relationship between one light emitting diode and the precharge circuit is illustrated. However, according the embodiment, people of ordinary skill in the art can integrate the whole organic light emitting diode array.

The second embodiment differs from the first embodiment by the design of the reference voltage V_{ref}. The function and connection of comparator 54 and the switching device 52 are the same as the comparator 44 and the switching device 42 described in the first embodiment, so that the description is not repeated.

In the first embodiment, the reference voltage V_{ref} is adjusted and varied ref externally. That is, the reference voltage V_{ref} cannot be adjusted dynamically. Under such circumstance, when the brightness of the organic light emitting diode 30 is changed, or the I-V-B characteristic curve is changed, the dynamic adjustment of the reference voltage V_{ref} is crucial. In the second embodiment, a ref sample and hold circuit is added to extract the voltage output from the constant current I. The sampling position of the sample and hold circuit is located at the rear output terminal with stable voltage to dynamically adjust the reference voltage V_{ref}.

Referring to FIG. 6A, one input terminal of the comparator, for example, the positive “+” input terminal, is coupled to a reference voltage V_{ref}. The output of the constant current source I is coupled to a positive “+” input terminal of the comparator 54 via a switching device 56. In addition, a capacitor C can be added between the positive terminal of the comparator 54 and the output of the switching device 56 to filter the sampling signal.

To perform sampling/holding, the rear edge of the voltage signal is sampled. As shown in FIG. 6B, the sample/hold signal 58 outputs an S/H signal, which is in a form of a series of pulses. The voltage signal extracted by the output of the constant current source I includes a segment data signal as shown in FIG. 6B. As shown in FIG. 6B, when the S/H signal is high, the switching device 56 is open to perform sample and hold voltage signal on the rear edge of the segment data signal (the falling edge of the pulse). The sampled and held voltage is used as a reference voltage V f input to the positive terminal of the comparator 54. Thereby, the reference voltage is dynamically adjusted according to the voltage of the anode of the organic light emitting diode 30.

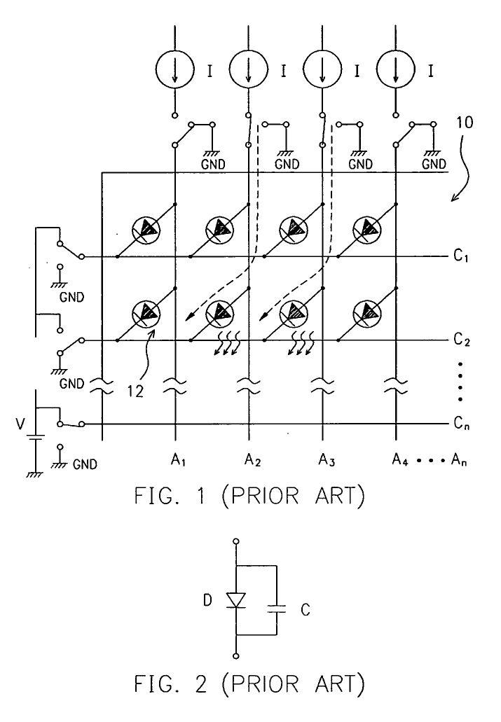

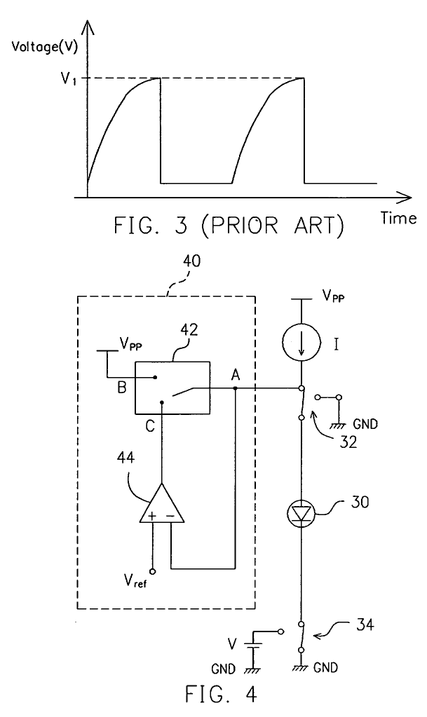

In the organic light emitting diode display, as the conductive line connecting the anodes in the same column has a resistance increases as the distance to the current source I increases. With the output of the constant current I, the voltage output to the anodes in the same column increases as the distance between the anode and the current source I increases. In the sample of the column serially connected to the anode line A₂ as shown in FIG. 1, as the anodes serially connected to the anode line A₂ provide the same current source I, that is, the current I is constant, the voltage is higher for the anode with a distance to the current source I farther than that of other anodes. In the second embodiment, as the reference voltage V_{ref} is obtained by sampling one by one along the column direction of the organic light emitting diode array, the reference voltage is adjusted dynamically for each organic light emitting diode to reduce the error between the reference voltage V_{ref} and the stable state of each light emitting diode.

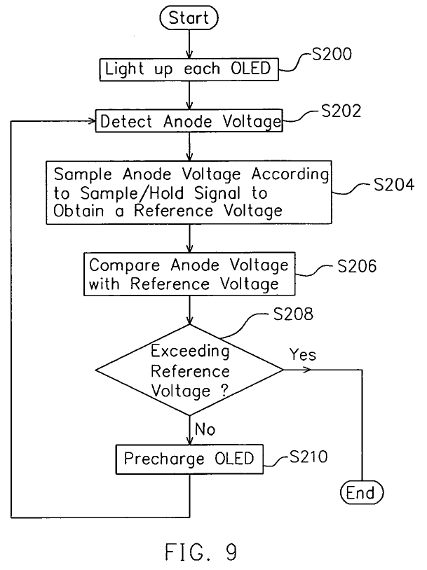

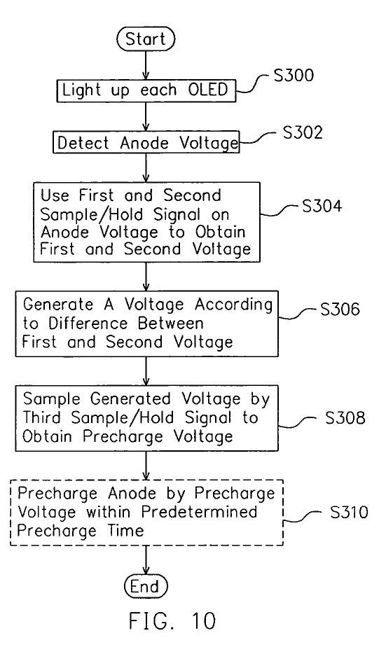

FIG. 9 shows a process flow of a driving method according to a second embodiment of the present invention. Referring to FIGS. 6A and 9, the organic light emitting diode 30 is lighted up, so that the anode voltage of the organic light emitting diode is raised in step S200. In step S202, the anode voltage of the organic light emitting diode 30 is detected and fed back to an input terminal of a comparator. In step S204, according to a sampling signal, the anode is sampled/held, and the resulting voltage of the anode is referred as a reference voltage. In step S206, the detected anode voltage is compared to the reference voltage obtained by sampling/holding step in step S204.

In step S208, when the detected anode voltage is lower than the reference voltage, a power source is applied to the anode of the organic light emitting diode 30 for performing precharge (step S210). The steps of S202 to S208 are repeated until the anode voltage reaches the reference voltage, and the precharge step is stopped.

### Third Embodiment

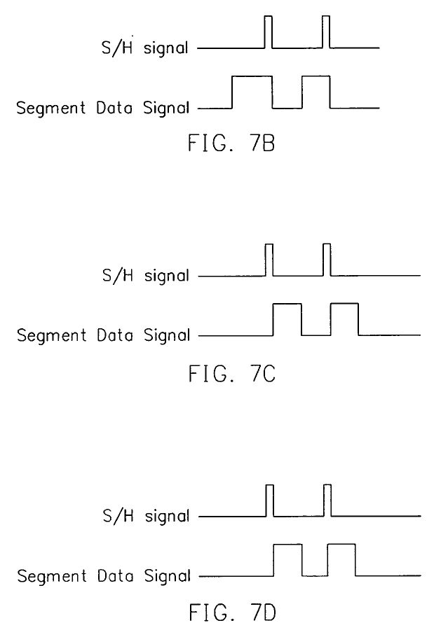

Referring to FIG. 7A, a circuit for driving the organic light emitting diode according to a third embodiment of the present invention is illustrated. For the convenience of description, only the relationship between one light emitting diode and the precharge circuit is illustrated. However, according the embodiment, people of ordinary skill in the art can integrate the whole organic light emitting diode array.

In the first and second embodiments, a constant precharge voltage is used to adjust the precharging time. That is, in FIGS. 6A and 7A, the precharge voltage Vₚₚ is constant. However, with such structure, the actual precharging time cannot be controlled. Instead, a feedback mechanism has to be used for automatic control. Therefore, when the uniformity of the output of anode voltage is highly demanded, particularly while using pulse-width modulation method for gray scale, the charging time is preferably shorter. Thus, in the third embodiment, the precharging time is fixed, while the voltage source Vₕ is varied. Two sets of sample/hold circuits are used to sample/hold the front end and the rear end of the output signal of the constant current source.

As shown in FIG. 7A, the precharge circuit 60 comprises switching devices 62a, 62b, 62c, an operation amplifier 64, sample/hold circuits 66a, 66b, and 66c. The operation amplifier 64 has two input terminals coupled to the output terminal of the constant current source I via the sample/hold circuit 66b, the switching device 62b, the sample/hold circuit 66c, and the switching device 62c, respectively. The voltage signals received by the amplifier 64 is processed to output to a gate g of a MOS transistor G. The drain d of the MOS transistor is coupled to a voltage source Vₕ, and the sources thereof is coupled to the output terminal of the constant current source I via the sample/hold circuit 66a. According to the type of the MOS transistor G, an inverter 68 can be coupled to the gate g and the operation amplifier 64. In addition, capacitors C₁, C₂ can be connected to the output terminals of the switching devices 62b, 62c and the input terminal of the operation amplifier 64 to filter the signal sampled by the sample/hold circuits 66b, 66c, respectively.

The operation of the precharge circuit as shown in FIG. 7A is described as follows. To light up the organic light emitting diode, the current provided by the constant current source is to flow through the organic light emitting diode 30, such that the anode voltage thereof is increased. Meanwhile, the sample/hold circuits 66b and 66c start sampling the output terminal of the constant current source (the anode of the organic light emitting diode 30. The sample/hold circuits 66b and 66c perform sampling on the rear edge and the front edge of the voltage signal. As shown in FIGS. 7B and 7C, the sample/hold circuits 66b, 66c output an S/H signal in a form of a series of pulses. The voltage signal extracted from the output terminal of the constant current source I is illustrated as the segment data signal as shown. From FIG. 6B, when the S/H signal is high, the switching device 62b switches on the rear edge of the segment data signal (the falling edge of the pulse) to perform sampling and holding on the voltage signal. The sample/hold voltage is then referred as a first voltage V₁ input to the positive “+” terminal of the comparator 64. In addition, as shown in FIG. 7C, when the S/H signal is high, the switching device 62c switches the front edge of the segment data signal (the rising edge of the pulse) to perform sample and hold of the voltage signal. The sampled/hold voltage is then used as a second voltage V₂ input to the negative “−” input terminal of the comparator 64.

The noise of the first and second voltages V₁ and V₂ are filtered by the capacitors C₁ and C₂, respectively. The operation amplifier 64 receives the first and second voltages V₁ and V₂ to output a voltage signal to the gate g of the MOS transistor G. Thereby, the gate voltage of the MOS transistor G is adjusted. Further, the voltage V_{d} (that is, Vₕ) and the current I_{gs} of the drain is adjusted by the voltage difference V_{gs} between the gate and the source of the MOS transistor G.

Referring to FIG. 7C, according to the voltage signal of the source of the MOS transistor conducted by the sample/hold circuit 66a, when the S/H signal is high, the switching device 62a switches on the front edge of the voltage signal (the rising edge of the pulse) to perform sample and hold on the voltage signal. The sample/held voltage is then used to precharge the organic light emitting diode within the predetermined precharging time.

FIG. 10 shows the process flow of a driving method according to the third embodiment of the present invention. Referring to FIGS. 7A and 10, in step S300, the organic light emitting diode 30 is lighted up, and the anode voltage thereof is increased. In step S302, the anode voltage of the organic light emitting diode 30 is detected.

In step 5304, according to a first sampling signal and a second sampling signal, the anode is sampled/held to obtain a first voltage and a second voltage. In step S306, a voltage is generated according to the difference between the first and second voltages. For example, in FIG. 7A, the voltage difference between the gate and source of the MOS transistor G is controlled by the voltage difference between the first and second voltages.

In step S308, according to a third sample/hold signal, the voltage obtained in step S306 is sampled to obtain a precharge voltage. In step S310, within a predetermined charging time, the precharge voltage obtained by sampling is applied to the organic light emitting diode to perform precharge.

By the operation method of the circuit as shown in FIG. 7A, the voltage source can be dynamically adjusted via the sample/hold circuit within the predetermined charging time. Therefore, when the uniformity of the anode voltage output is highly demanded particularly while applying PWM to gray scale, the charging time is shortened.

According to the above, compared to the prior art, the passive driving circuit of the organic light emitting diode provided by the present invention has at least the following advantages and functions.

By precharging the anode of the organic light emitting diode, the passive driving circuit of the organic light emitting diode provided by the present invention increases the conductance speed and obtains the appropriate driving voltage quickly.

The passive driving circuit of the organic light emitting diode provided by the present invention uses a sample/hold circuit to dynamically change the reference voltage of the precharge circuit. When the circuit outputs a constant current, the corresponding reference voltage for each organic light emitting diode in the same column can be dynamically adjusted to increase the rising speed of the anode voltage without diffusing the current for driving the organic light emitting diode.

The passive driving circuit of the organic light emitting diode provided by the present invention uses a sample/hold circuit to dynamically change the voltage source within a predetermined charging time, such that the charging time is shortened when the uniformity of the anode voltage output is highly demanded.

The passive driving circuit of the organic light emitting diode provided by the present invention precharges the anode of the organic light emitting diode. Therefore, the brightness is sufficient and uniform without consuming driving current to charge the parasitic capacitor.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. (canceled)

2. (canceled)

3. (canceled)

4. A passive driving method of an organic light emitting diode, comprising:
applying a voltage to an organic light emitting diode to increase a voltage of an anode thereof;
detecting the voltage of the anode;
performing a sample/hold step on the detected voltage of the anode according to a sampling signal to obtain a sampled voltage as a reference voltage;
comparing the detected voltage of the anode with the reference voltage;
applying a voltage of the organic light emitting diode to perform precharge when the detected voltage of the anode is lower than the reference voltage; and
stopping the precharge when the detected anode voltage reaches the reference voltage.

5. The method according to claim 4, further comprising using the sampling signal to perform sample/hold on a falling edge of the voltage of the anode to obtain the reference.

6. A passive driving circuit of an organic light emitting diode, comprising:
applying a voltage to an organic light emitting diode to increase an anode voltage thereof;
detecting the anode voltage of the organic light emitting diode;
performing sample/hold on an anode of the organic light emitting diode according to a first sampling signal and a second sampling signal to obtain a first voltage and a second voltage;
generating a voltage according to a difference between the first and second voltages obtained by sampling; and
precharging the anode of the organic light emitting diode within a precharging time according to the generated voltage.

7. The method according to claim 6, further comprising sampling the generated voltage according to a third sampling signal to obtain a precharge voltage, and performing precharge on the anode of the organic light emitting diode according to the precharge voltage.

8. The method according to claim 7, further comprising using the first sampling signal to perform sample/hold on a falling edge of the anode voltage to obtain the first voltage.

9. The method according to claim 7, further comprising using the second sampling signal to perform sample/hold on a rising edge of the anode voltage to obtain the second voltage.

10. The method according to claim 7, further comprising using the third sampling signal to perform sample/hold on a rising edge of the generated voltage to obtain the precharge voltage.
